(19) United States
(12) Patent Application Publication
(10) Pub. No.: US 2006/0049556 A1
(43) Pub. Date: Mar. 9, 2006

(54) Device for homogeneous impingement of a planar surface of a tool with a heated gas

(76) Inventor: Dirk Menzler, Aachen (DE)

Correspondence Address: PROSKAUER ROSE LLP;PATENT DEPARTMENT, 1585 BROADWAY, NEW YORK, NY, 10036-8299, US

(21) Appl. No.: 10/507,531

(22) PCT Filed: Feb. 14, 2003
(86) PCT No.: PCT/DE03/00454

§ 371 Date: Jul. 1, 2005

(30) Foreign Application Priority Data
Mar. 19, 2002 (DE) 102 12 234.2

(51) Int. Cl. C21D 1/06

(52) U.S. Cl. 266/252

(57) ABSTRACT

The device for homogeneous impingement of a planar surface (2) of a tool with a heated gas comprises a nozzle plate (5) which is provided with nozzles (3) and which extends in a parallel position to the planer surface, being provided with openings for the nozzles (3). The nozzles (3) are disposed in a normal position with regard to the surface (2) which is to be impinged upon and are embodied in a tubular form. A spiral-shaped deflector device (6) is arranged therein. Since the gas jets impact upon the surface (2) to be impinged upon in a normal position, the shortest possible jet path arises and heat transition loss is reduced. Spiral shaped guidance of the jets increases the cross-sectional area upon exit, whereupon the surface (2) to be impinged upon is covered in a homogeneous manner when the nozzles (3) are arranged in a suitable manner.

The invention relates to a device for evenly applying heat to a plane surface of a work piece by means of a heated gas, wherein a nozzle bottom comprising nozzles is provided, which nozzle bottom is arranged parallel to the plane surface and comprises apertures for the nozzles.

Such devices are for example used for heating sheet metal strip which has been coiled. When hot gas is blown onto the faces of such a coil, the best-possible heat transmission is desired so that the treatment duration can be kept as short as possible. Furthermore, excessive heating of individual areas, in particular of the strip edges of coils, is to be avoided. Consequently, as favourable an arrangement as possible should be found which makes possible heat transmission that is as even and as high as possible.

A device of the type mentioned in the introduction is for example described in DE 196 50 965. It comprises a flat nozzle bottom with nozzle apertures which direct the issuing gas stream onto the surface of the work piece at an inclined angle to said surface. Furthermore, the nozzles are arranged in groups and, as far as their deflection direction is concerned, are arranged in such a way in relation to each other that the projection of the nozzle streams of two adjacent nozzles of a group form an angle which is obtained by dividing 360° by the number of nozzles belonging to a group.

This arrangement is disadvantageous in particular because of the long stream path which results from the inclination of the stream axis of an individual nozzle in relation to the perpendicular on the nozzle bottom of a group, which long stream path results in a large reduction of heat transmission as the distance from the nozzle bottom increases.

It is thus the object of the invention to create a device of the type mentioned in the introduction, which device significantly lessens the reduction in heat transmission when compared to known devices of a relevant type, and which device increases the evenness of heat distribution.

According to the invention, in a device of the type mentioned in the introduction, this object is met in that the nozzles are of tubular shape; in that a deflection device is arranged in them which provides spiral-shaped guidance to the gas; and in that the nozzles are arranged perpendicular in relation to the surface to which heat is to be applied.

This nozzle design results in streams which are precisely defined by their guidance. Since the gas streams hit the surface to be heated perpendicularly, the shortest possible stream path and a lessening in the reduction of heat transmission results. As a result of the spiral-shaped guidance of the streams, their diameter increases in the direction of the stream so that the surface to be heated can be covered evenly if the nozzles are suitably arranged.

The device according to the invention can be of such a design that the deflection device is made up of one metal strip or several metal strips which are each made up of one or several metal strips being evenly distributed around the circumference of the nozzle and being spiral-shaped within the nozzle, wherein the width of said metal strip(s) matches/match the radius of the nozzle, and in that the spiral-shaped arrangement in n metal strips extends over at least 360°/n so that the projections of the deflection devices fully cover the cross-section of the respective nozzle. This prevents the gas streams from essentially flowing in a straight line through the deflection device and thus from failing to deflect and expand in the desired way after issuing from the nozzle. Furthermore, this arrangement will prevent a heating device arranged on the inflow end of the nozzle bottom from influencing the stream.

The stream of a nozzle can be advantageously influenced if the deflection device comprises at least two flow channels of spiral-shaped arrangement.

An advantageous arrangement of the nozzles on the nozzle bottom can be achieved if the nozzles are arranged so as to be equidistant on straight lines which are in a perpendicular position in relation to each other, and if the spiral-shapes of the nozzles which are arranged side-by-side on a common straight line are arranged in opposite directions. This gives adjacent gas streams a direction which clearly promotes the evenness of gas stream distribution and thus also the heating of the surface to be heated up.

Advantageously, the deflection devices can extend along the entire length of a nozzle so that the gas stream which passes through can be exposed to a swirling movement along the longest possible length.

According to the invention, the nozzles are preferably arranged on the outflow end of the nozzle bottom, however, in specific applications they can also be located on the inflow end.

Below, the device according to the invention is described by means of one embodiment. The following are shown:

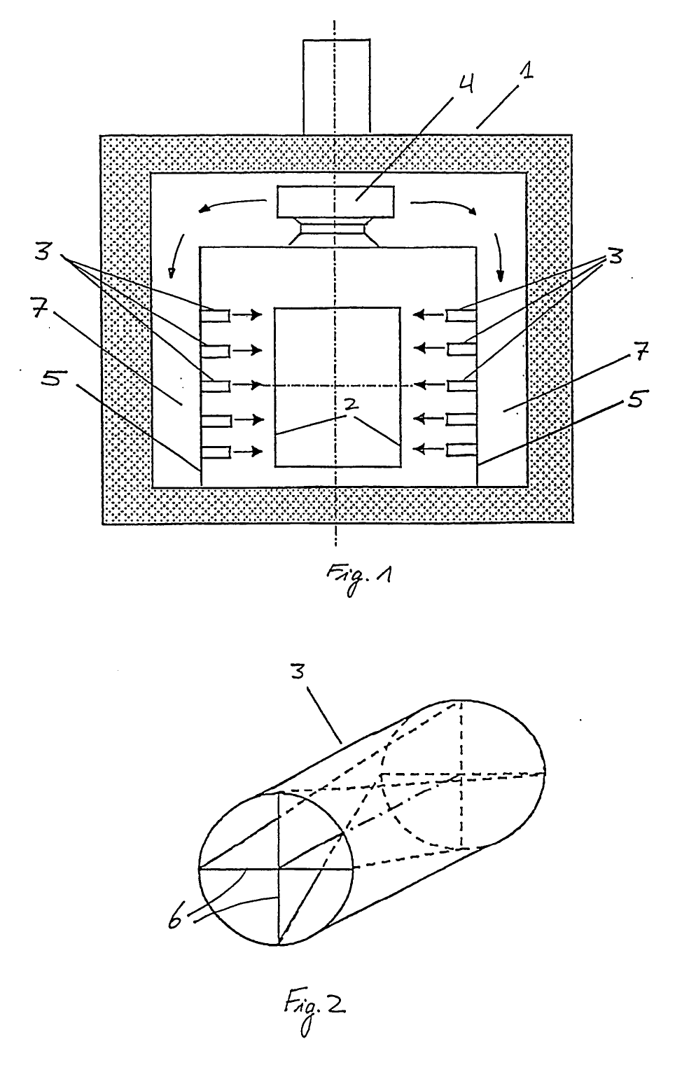

FIG. 1: a horizontal section of a furnace in which the surfaces of the material to which hot gas is to be applied are heated up by hot gas blowing from two opposite sides;

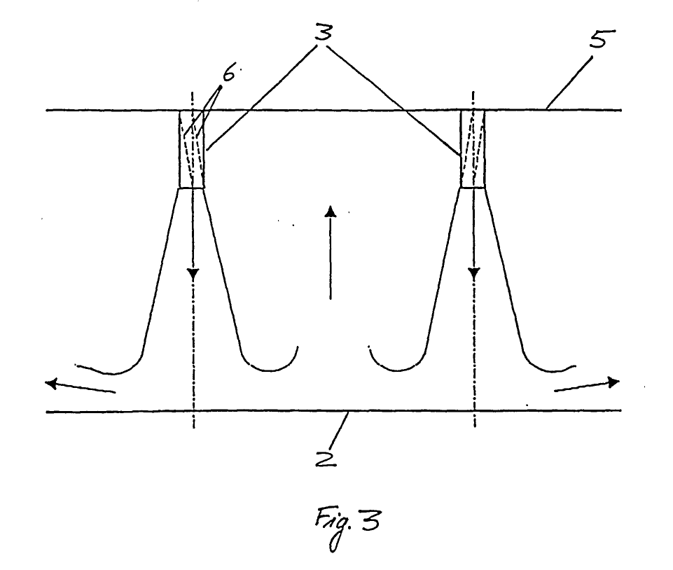

FIG. 2: a perspective view of a tubular nozzle in which a deflection device comprising two metal strips is arranged; and

FIG. 3: the flow path of the gas between the nozzles and the surface of the material to which hot gas is to be applied.

FIG. 1 shows a furnace 1, in which the surfaces 2 of the material to which heat is to be applied are exposed to hot gas from the tube-shaped nozzles 3. In this arrangement, a fan 4 takes hot gas from the furnace space and conveys said hot gas on the inflow side 7 of the nozzle bottom 5 to the nozzles 3 arranged on the outflow end of the nozzle bottom 5. The heating device necessary for heating the gas is not shown.

FIG. 2 shows an example of a nozzle 3 according to the invention, which nozzle has a circular cross-section. A deflection device 6 has been arranged in the nozzle 3 along the entire length of said nozzle 3. In the embodiment shown, said deflection device 6 comprises two radially intersecting material strips so that the interior of the nozzle is divided into four separate flow channels. In this arrangement, the deflection device 6 is arranged so as to be in a spiral shape in relation to the axis of the nozzle, extends along the entire length of the nozzle, and is rotated by 90°. This imparts a swirling movement to the gas that flows through the nozzle, thus excluding an essentially straight-line through-flow.

FIG. 3 shows the flow path of the gas between the nozzle bottom 5 and the surface 2 to which hot gas is to be applied. In the embodiment shown, the nozzles 3 are arranged at the outflow side of the nozzle bottom 5 perpendicular in relation to the surface 2 to which hot gas is to be applied. The direction of flow of the gas is indicated by arrows. When the gas flows through the nozzles 3, the deflection device imparts an alignment to said gas. This alignment causes the cross-sectional area of the gas stream to increase in the direction of propagation. The increase in the cross-sectional area depends on the swirling movement imparted to the gas in the deflection device so that the impact surface of a stream can be determined accordingly. After the stream has reached the surface 2, the gas flows back between the nozzles 3.

### LIST OF REFERENCE CHARACTERS

1 Furnace
2 Surface of the material to be heated
3 Nozzles
4 Fan
5 Nozzle bottom
6 Deflection device
7 Inflow side

1. A device for evenly applying heat to a plane surface of a work piece by means of a heated gas, wherein a nozzle bottom comprising nozzles is provided, which nozzle bottom is arranged parallel to the plane surface and comprises apertures for the nozzles,
wherein
the nozzles are of tubular shape; in that a deflection device is arranged in them which provides spiral-shaped guidance to the gas; and in that the nozzles are arranged perpendicular in relation to the surface to which heat is to be applied.

2. The device according to claim 1,
wherein
each deflection device is made up of one metal strip or several metal strips which are each made up of one or several metal strips being evenly distributed around the circumference of the nozzle, and being spiral-shaped within the nozzle, wherein the width of said metal strip(s) matches/match the radius of the nozzle, and in that the spiral-shaped arrangement in n metal strips extends over at least 360/n°.

3. The device according to claim 1,
wherein
the deflection device comprises at least two flow channels of spiral-shaped arrangement.

4. The device according to claim 1,
wherein
the nozzles are arranged so as to be equidistant on straight lines which are in a perpendicular position in relation to each other, and the spiral-shapes of the nozzles which are arranged side by-side on a common straight line are arranged in opposite directions.

5. The device according to claim 1,
wherein the deflection device is at least one metal strip which extends in spiral-shape on the axis of the nozzle.

6. The device according to claim 1,
wherein
the deflection device extends along the entire length of a nozzle.

7. The device according to claim 1,
wherein
the nozzles are arranged on the outflow side of the nozzle bottom.
